(19) United States
(12) Patent Application Publication
(10) Pub. No.: US 2015/0192739 A1
(43) Pub. Date: Jul. 9, 2015

(54) METHOD FOR MANUFACTURING MULTI-FIBER BUNDLES

(71) Applicant: Gary A. Miller, Alexandria, VA (US)

(72) Inventor: Gary A. Miller, Alexandria, VA (US)

(21) Appl. No.: 14/589,143

(22) Filed: Jan. 5, 2015

Related U.S. Application Data
(60) Provisional application No. 61/924,269, filed on Jan. 7, 2014.

(51) Int. Cl. G02B 6/255; C03C 25/62; B23K 1/14; G02B 1/10; B23K 1/00; C03C 25/10; C03B 37/028

(52) U.S. Cl. CPC G02B 6/2551; C03C 25/104; C03C 25/6233; C03B 37/028; G02B 1/10; B23K 1/0008; B23K 1/14; B23K 2001/12

(57) ABSTRACT

A method of manufacturing a multi-fiber bundle. The multi-fiber bundle includes a multi-fiber bundle neutral axis. The multi-fiber bundle includes at least three optical fibers. The at least three optical fibers includes respective optical fiber neutral axes. The at least three optical fibers are registered such that at least a portion, of the multi-fiber bundle neutral axis remains at a constant distance front at least a portion of the respective optical fiber neutral axes. The at least three optical fibers are coated with an optical fiber coating material. The at least three coated optical fibers are cured.

### CROSS-REFERENCE TO RELATED APPLICATIONS

This application claims priority to U.S. Provisional Patent Application Ser. No. 61/924,269, entitled “FABRICATION OF MULTI-FIBER OPTICAL SENSOR/” to Miller, which was filed on 7 Jan. 2014 and is incorporated herein by reference.

### BACKGROUND OF THE INVENTION

Multicore optical fiber has many positive attributes, chiefly due to the separation of the cores fern the fiber's neutral axis. This property enables the fiber to be used for differential strain measurements (typically using fiber Bragg gratings) in free space or while attached to a sub-structure. Became cores opposite of the neutral, axis experience tension and compression, the resultant strain vector reveals information about the bending amplitude and orientation.

Despite the potential advantages of multicore fiber, there are numerous drawbacks to using this type of fiber for optical devices. The first drawback is this fiber's availability. Few manufacturers produce molts core fiber, and those that do, either produce a single design or are unwilling to draw limited quantities of specialty fiber, furthermore, because most newly designed fibers require multiple iterations between the end user and the manufacturer, the process can become cost-prohibitive. The second drawback is that connecting to the fiber is challenging and often unreliable. Because the fiber has multiple cores, each core most be addressed to obtain the measurement signal This is commonly achieved by using a fiber fan-out, a custom fiber optic switch, or tapering the fiber and splicing to a conventional single mode fiber. These methods typically have high insertion losses and limit the operating performance of the sensor. The third drawback is that inscribing the sensors within the fiber is difficult and can lead to reproducibility issues. Depending on the geometry, peripheral cores or internal structure within the fiber can also obscure distal cores during the exposure procedure, making it necessary to perform multiple exposures, shadow certain cores from exposure, or index match the exposure.

### BRIEF SUMMARY OF THE INVENTION

To address these limitations. Applicant conceived a novel solution involving a bundling of several single mode optical fibers in a geometry reminiscent of a multicore fiber. Applicants solution involved use of commercially available single mode fibers that are stacked and attached along their tangential contact points. The resultant multi-fiber bundle (“MFB”) provides a mechanically sound, multicore optical structure with individual fiber pigtails available for connectorization. Additionally, because the process cars be highly localized or implemented at low temperatures according to an embodiment of the invention, the MFB can be fabricated with optical fibers containing fiber Bragg gratings (“FBGs”) or other optical structures that would anneal or otherwise be destroyed upon heating.

An embodiment of the invention includes a method of manufacturing a multi-fiber bundle. The multi-fiber bundle includes a multi-fiber bundle neutral axis. The multi-fiber bundle includes at least three optical fibers. The at least three optical fibers includes respective optical, fiber neutral axes. The at least three optical fibers are registered such that at least a portion of the multi-fiber bundle neutral axis remains at a constant distance from at least a portion of the respective optical fiber neutral axes. The at least three optical fibers are coated with an optical fiber coating material lire at least three coated optical fibers are cured.

Another embodiment includes a method of manufacturing a multi-fiber bundle. The multi-fiber bundle includes a multi-fiber bundle neutral axis. The multi-fiber bundle includes at least three optical fibers. The at least three optical fibers includes respective optical fiber neutral axes. The at least three optical fibers includes scams. The scams include tangential locations of the at least three optical fibers. The at least three optical fibers are registered such that at least a portion of the multi-fiber bundle neutral axis remains at a constant distance from at least a portico of the respective optical fiber neutral axes. The seams of the at least three optical fibers are fused.

Applicant has determined that the utilization of an MFB in place of a multicore fiber, in accordance to one or more embodiments of the instant invention, has several advantages. First, because a single mode fiber, for example, is used to form the MFB, the amount of available optical fiber is significantly increased. There are numerous fiber manufacturers capable of making excellent single mode fiber and at a reduced cost when compared to a multicore fiber counterpart. Using single mode fiber also enables the capability of bundling fibers with vastly different core parameters and host materials (generally not achievable with multicore fiber). Second, by bundling individual fibers, the connectivity issue becomes nonexistent. Because each fiber end is free, connecting to the MFB is achieved by splicing to the individual fibers. Fusing the fibers or using silica coatings also provides thermal and mechanical robustness to the MFB. Since the host material is same, thermal uniformity across the bundle prevents non-uniform strain transfer. Lastly, the fibers can be modified prior to bundling to facilitate the incorporation of complicated structures within the fiber. This allows the fibers to be individually treated before they are integrated into a MFB. Some examples might include writing FBG arrays into the fibers (e.g., via “strip and re-coat” or in-line with a draw tower) or writing microstructures into the fibers using ultrafast laser processing. Because standard writing and processing techniques are already employed, the added complication of rotational alignment (as with conventional multicore fiber) is not necessary and greatly simplifies the manufacturing of optical devices.

### BRIEF DESCRIPTION OF THE DRAWINGS

FIG. 2 is a top cross-sectional view of a multi-fiber bundle, according to an embodiment of the invention.

FIG. 2A is a side cross-sectional view of multiple fibers in an alignment die, according to an embodiment of the invention.

FIG. 2B is a top cross-sectional view of multiple fibers in an alignment die, according to art embodiment of the invention.

FIG. 3A is an end cross-sectional view of-multiple fibers in a grooved fiber mount, according to an embodiment of the invention.

FIG. 3B is a side cross-sectional view of multiple fibers in a grooved fiber mount, according to an embodiment of the invention.

FIG. 3C is a perspective view of multiple fibers in a fiber mount with alignment rails, according to an embodiment of the invention.

FIG. 4 is a side cross-sectional view of multiple fibers communicating with a coating cup having an alignment die, according to an embodiment of the invention.

FIG. 5A is a side cross-sectional view of multiple fibers in a fiber mount being immersed in a coating fluid during a dip coating, according to an embodiment of the invention.

FIG. 5B is a side cross-sectional view of multiple fibers in a fiber mount being withdrawn from a coating fluid during a dip coating, according to an embodiment of the invention.

FIG. 6 is a side cross-sectional view of multiple fibers in a fiber mount being brushed with a moving applicator, according to an embodiment of the instant invention.

FIG. 7 is a side cross-sectional view of multiple fibers in a fiber mount being sprayed with a moving spray nozzle, according to an embodiment of the instant invention.

FIG. 8 is a side cross-sectional view of multiple fibers being cured in an oven or UV lamp, according to an embodiment of the invention.

FIG. 9 is a side cross-sectional view of multiple fibers being cured using a laser, according to an embodiment of the invention.

FIG. 10 is a side cross-sectional view of multiple fibers being cured under a UV light source, according to an embodiment of the invention.

FIG. 11A is a side cross-sectional view of multiple fibers being cared in an oven, according to an embodiment of the invention.

FIG. 11B is a side cross-sectional view of multiple fibers being cured using a tube furnace, according to an embodiment of the invention.

FIG. 12 is a side cross-sectional view of multiple fibers being cured using a treat source, such as a hot plate, wherein either the fiber mount is stationary and the beat source moves, or the fiber mount moves and the heat source is stationary, according to an embodiment of the invention.

FIG. 13 is a side cross-sectional view of multiple fibers being cured under a heat gun, according to an embodiment of the invention.

FIG. 14 is a side cross-sectional view of multiple fibers being cured using a sintering laser, wherein either the fiber mount is stationary and the laser moves, or the fiber mount moves and the laser is stationary, according to an embodiment of the invention.

FIG. 15 is a side cross-sectional view of the scams of multiple fibers being fused using multiple lasers, according to an embodiment of the invention.

FIG. 16 is a side cross-sectional view of the seams of multiple fibers being fused using a single laser and beamsplitting optics, according to an embodiment of the invention.

FIG. 17 is a side cross-sectional view of the seams of multiple fibers being fused using a scanning laser and one or more mirrors, according to an embodiment of the invention.

FIG. 18A is a perspective view of multiple fibers about to be soldered using solder, according to an embodiment of the invention.

FIG. 18B is a perspective view of multiple fibers being soldered using solder, according to an embodiment of the invention.

FIG. 19A is a side cross-sectional view of multiple fibers being soldered using a brush on flux, according to an embodiment of the invention.

FIG. 19B is a side cross-sectional view of multiple fibers being soldered using fixed heat source, according to an embodiment of the invention.

FIG. 19C is a side cross-sectional view of multiple fibers being cooled down after being soldered, according to an. embodiment of the invention.

FIG. 20 is a top cross-sectional view of multiple fibers fused with a wire solder, according to an embodiment of the invention.

FIG. 21 is a top cross-sectional view of multiple fibers fused with a ribbon solder, according to an embodiment of the invention.

### DETAILED DESCRIPTION OF THE INVENTION

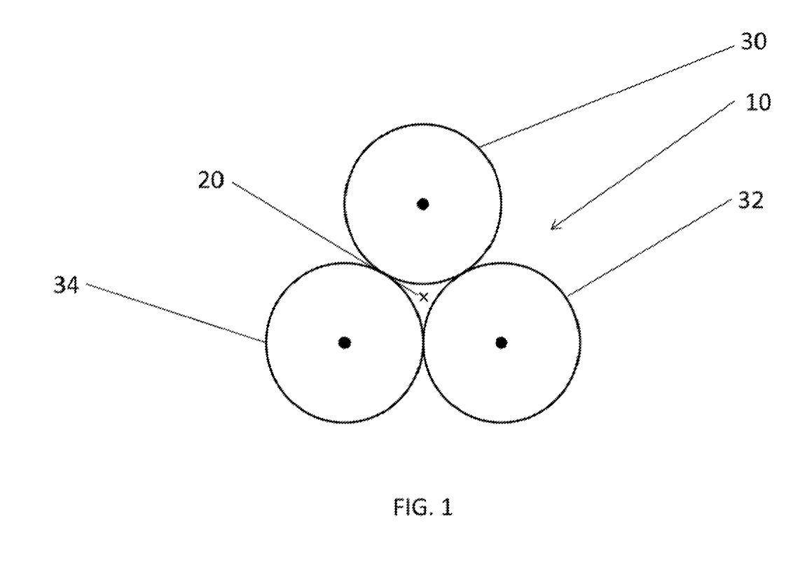

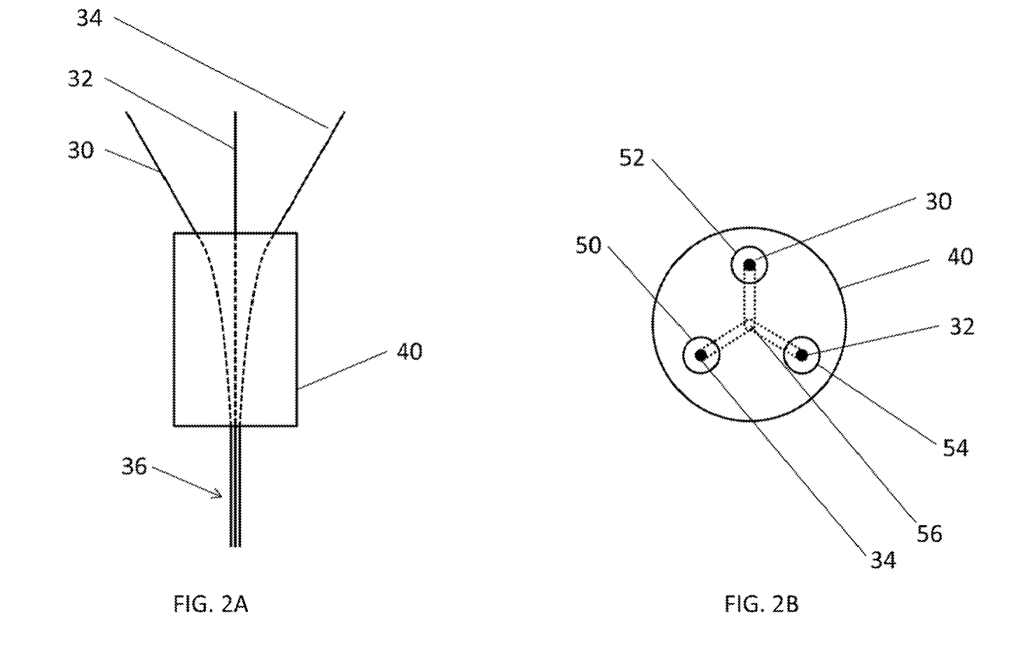

An embodiment of the invention includes a method of manufacturing a multi-fiber bundle 10, for example, as described by way of illustration in FIGS. 1 and 2A and 2B. The level of zero-bending stress is herein defined at the neutral axis. The multi-fiber bundle 10 includes a multi-fiber bundle neutral axis 20, as shown in FIG. 1. The level of zero-bending stress of the multi-fiber bundle 10 then is herein defined at the multi-fiber neutral axis. The multi-fiber bundle 10 includes at least three standard optical fibers 30, 32, 34. One of ordinary skill in the art will appreciate that although three optical fibers are shown in the figures, more optical fibers may be used in a multi-fiber bundle according to the instant invention depending on the application. The at least three optical fibers 30, 32, 34 includes respective optical fiber neutral axes. The levels of zero-bending stresses of the optical fibers are herein defined at their respective optical fiber neutral axes. The at least three optical fibers 30, 32, 34 are registered such that at least a portion of the multi-fiber bundle neutral axis 20 remains at a constant distance from at least a portion of the respective optical fiber neutral axes. The registered optical fibers 36 are coated with a standard optical fiber coating material. The coated optical fibers 38 are cured.

Optionally, the at least three optical fibers 30, 32, 34 include at least one of a standard single mode optical fiber, a standard multi-mode optical fiber, a standard gradient index optical fiber, a standard microstructured optical fiber, and a standard photonic crystal optical fiber. The at least three optical fibers include respective standard in-fiber refractive index structures, the respective in-fiber refractive index structures including at least one of a standard fiber Bragg grating, a standard long period grating, a standard super-structure grating, a standard tilted, grating, and a standard constant index change region.

Optionally, registering the at least three optical fibers includes cold-drawing the at least three optical fibers through a standard aligning die 40, such as shown by way of illustration in FIGS. 2A and 2B. The aligning die 40, for example, includes alignment holes 50, 52, 54 corresponding to the number of optical fibers 30, 32, 34. The alignment holes 50, 52, 54 provide entry points for the optical fibers into the alignment die. Each of the alignment holes 50, 52, 54, for example, is smooth and includes a large capture orifice at the top that tapers to the desired diameter. Coating fluid is advantageously used as a lubricant in the aligning die to reduce friction of the optical fibers' glass against the material of the aligning die 40. The aligning die 40, for example, also includes an exit bole 56 at the end or bottom of the aligning die, out of which comes the registered optical fibers.

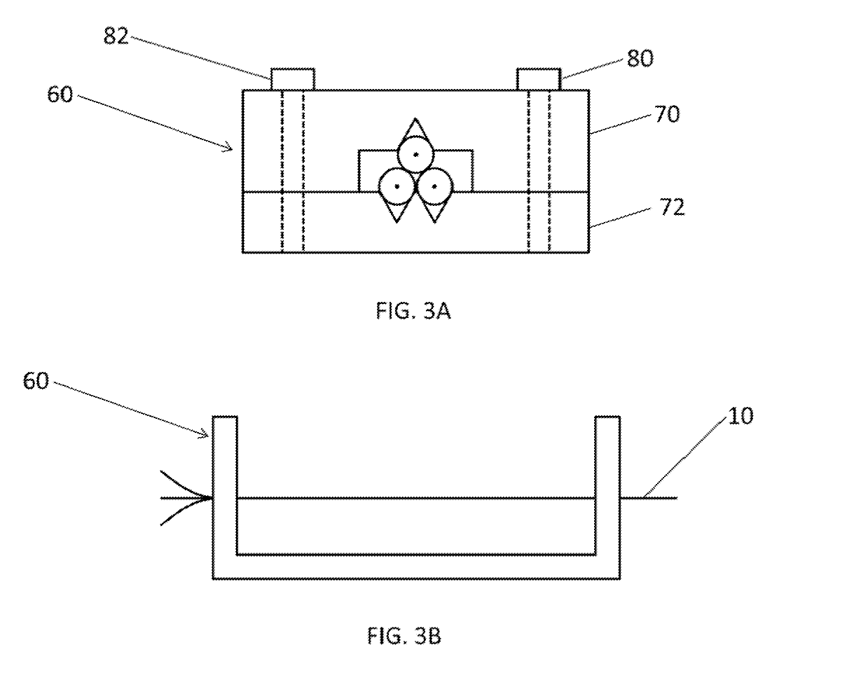

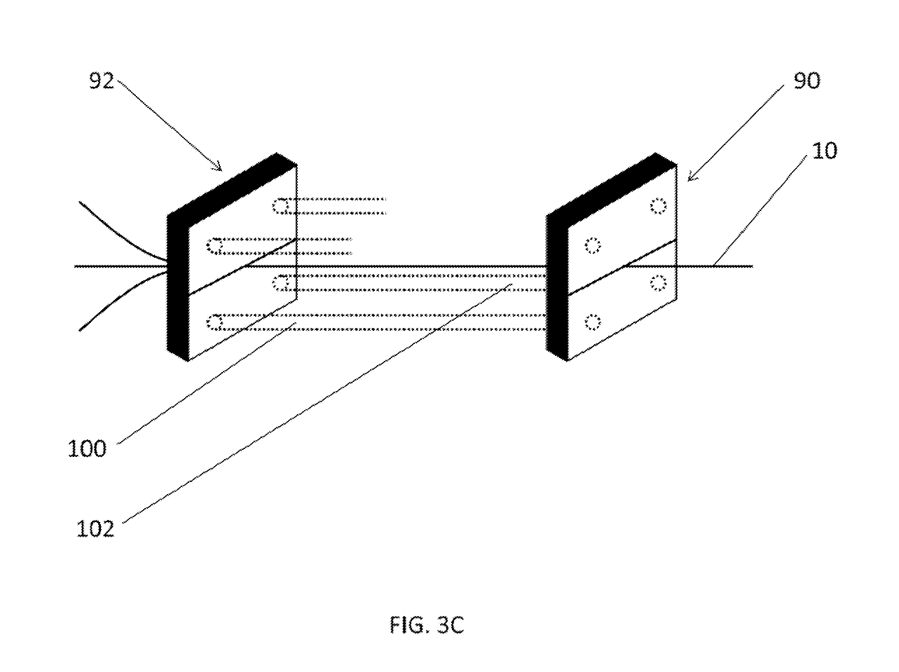

Alternatively, registering the at least three optical fibers 30, 32, 34 includes mounting the at least three optical fibers on a standard fiber mount 60, such as shown by way of illustration in FIGS. 3A and 3B. For example, the fiber mount 60 includes two standard grooved blocks 70, 72 on each end of the optical fibers 30, 32, 34 that hold the optical fibers in place during registration, as shown by way of illustration in FIG. 3A. For example, the two grooved blocks 70, 72 include standard V-shaped or channel grooves in which the optical fibers are positioned. For example, the two grooved blocks 70, 72 are held together with one or more standard clamping pins 80, 82. Alternatively, the fiber mount 60 includes a unitary body, as shown by way of illustration in FIG. 3B. Alternatively, the fiber mount 60 includes two fiber mount walls 90, 92 connected by one or more alignment rails 100, 102, as shown by way of illustration in FIG. 3C. For example, each fiber mount wall 90, 92 is unitary. Alternatively, each fiber mount wail 90, 92 includes cooperating wail blocks to hold, the optical fibers 30, 32, 34.

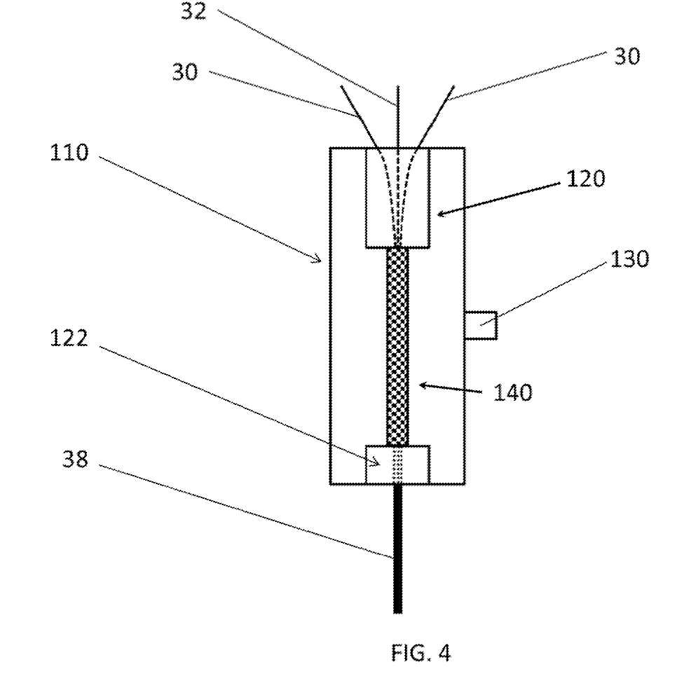

Optionally, a standard coating cup 110 is provided, for example as shown by way of illustration in FIG. 4. The coating cup 110 includes one or more standard coating cap aligning dies 120, 122. For example, the coating cup aligning dies 120, 122 include a top or entry coating cap aligning die 120 and a bottom or exit coating cup aligning die 122. The coating cap 110 contains the optical fiber coating material 150, For example, the optical fiber coating material is input into the coating cop 110 via a standard coating fluid inlet 130 and dispersed via a standard coating diffuser 140. The coating diffuser 140, for example, prevents the fluid flow from disturbing the optical fibers as they travel through the coating cup 110.

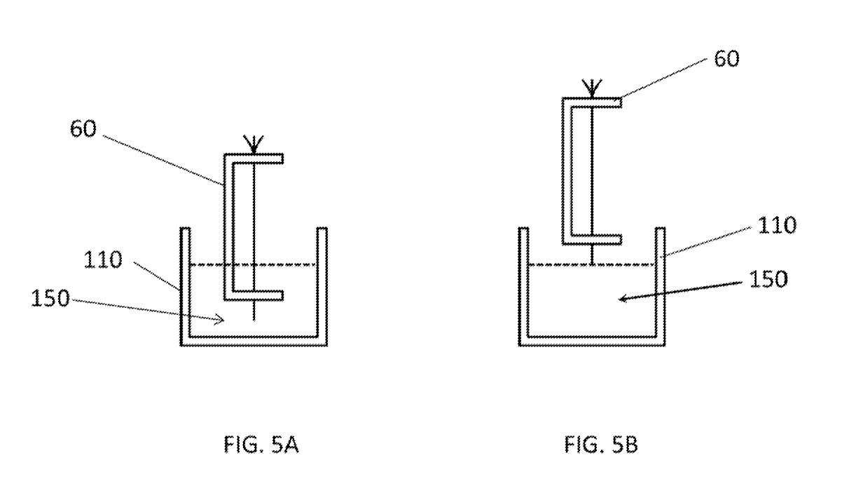

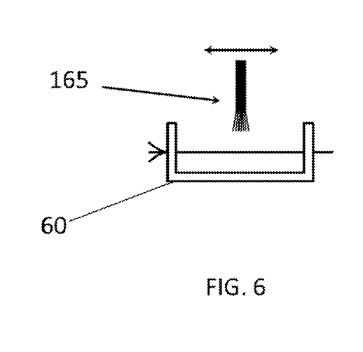

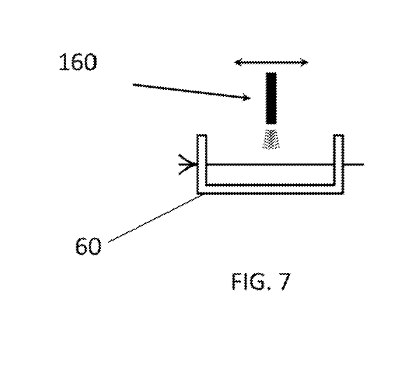

Optionally, coating the at least three optical fibers with an optical fiber coating material includes passing the at least three cold-drawn optical fibers through a coating cup to generate coated optical fibers 36, such as shown by way of illustration in FIG. 4. Alternatively, coating the at least throe optical fibers with an optical fiber coating material includes dip-coating the at least three mounted optical fibers with the optical fiber coating material, such as shown by way of illustration in FIGS. 5A, and 5B. Alternatively, coating the at least three optical fibers with an optical fiber coating material includes brushing the optical fiber coating material on the at least three mounted optical fibers with a brush 165 movable along a length of the optical fibers, such as shown by way of illustration in FIG. 6. Alternatively, coating the at least three optical fibers with an optical fiber coating material includes spraying the optical fiber coating material on the at least three mounted optical fibers with a spray nozzle 160 movable along a length of the optical fibers, such as shown by way of illustration in FIG. 7. Due of ordinary skill in the art will readily appreciate that a stationary brush or stationary spray nozzle cooperating with a movable fiber mount may be alternatively advantageous, depending on the application. One of ordinary skill, in the art will also appreciate that two or more of these coating methods may be advantageously combined, depending on the application.

Optionally, the optical fiber coating material 150 comprises ultra-violet-curable epoxy, acrylate, and sol-gel. For example, the sol-gel includes aerogel, xerogel, or freeze-dried sol-gel.

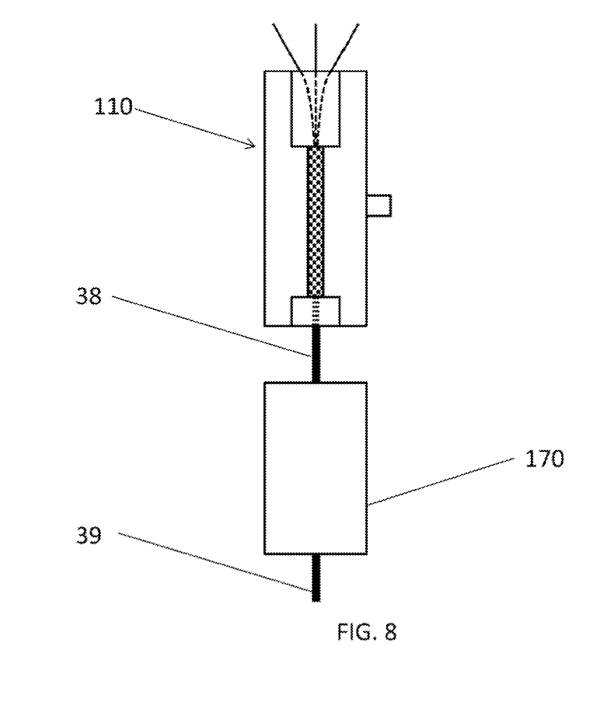

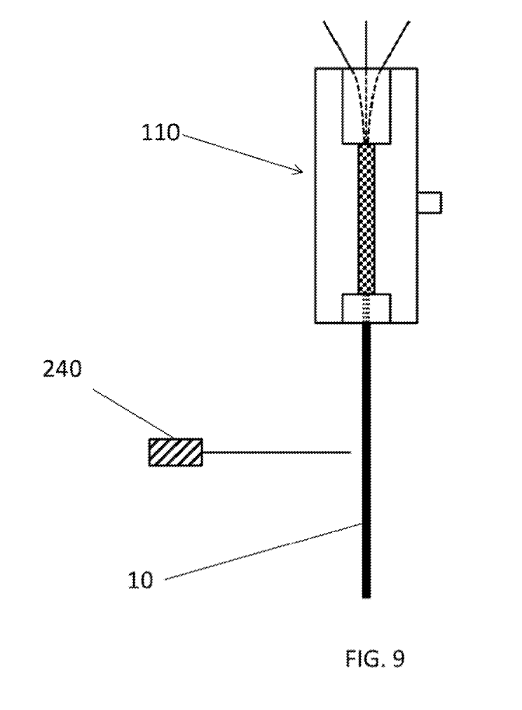

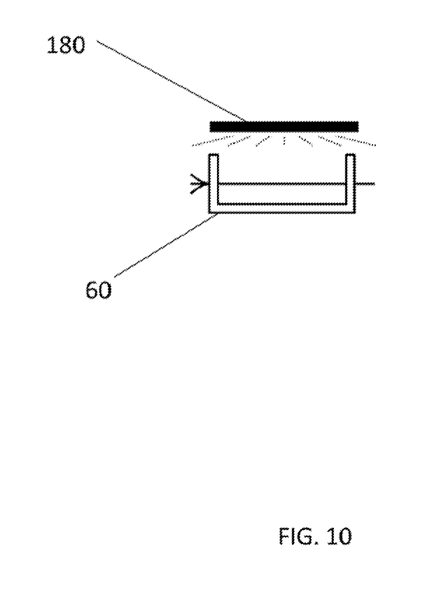

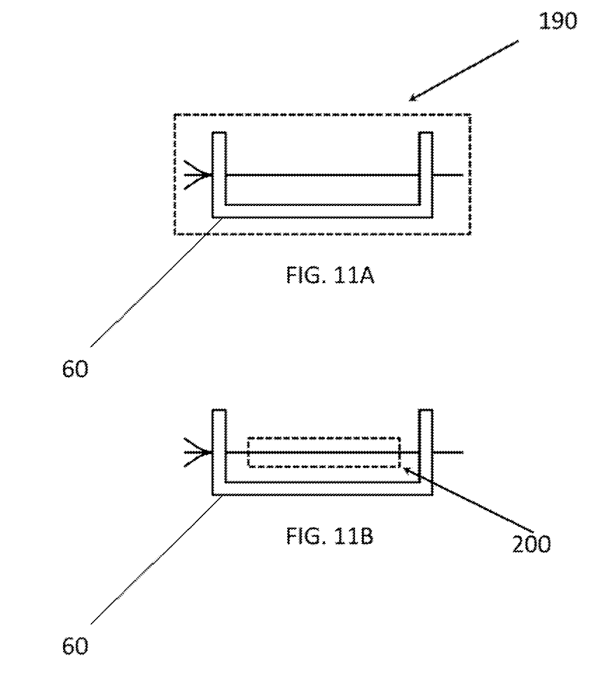

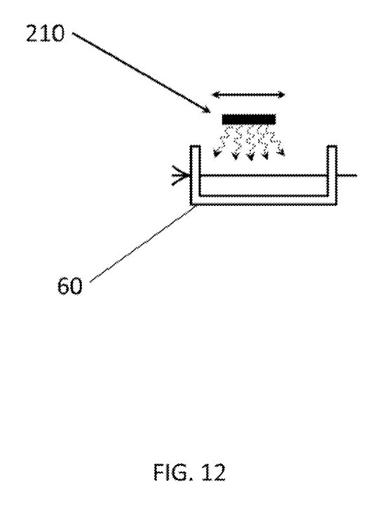

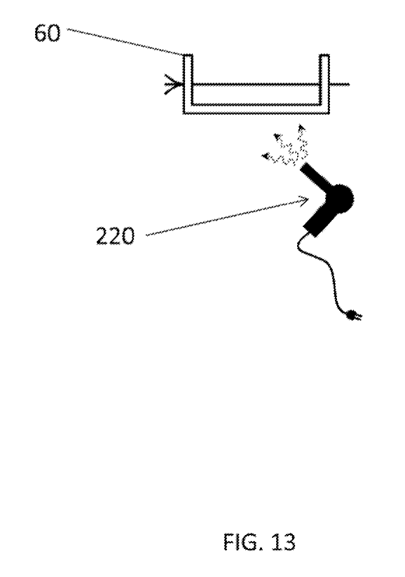

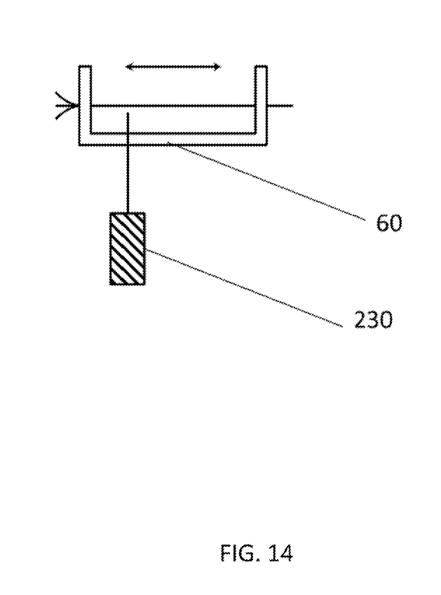

Optionally, coring the at least three coated optical fibers comprises employing a standard curing station 170 including a standard heat source, such as shown by way of illustration in FIG. 8, to generate cured optical fibers 39, thereby generating the multi-fiber bundle 10, For example, the standard heat source is a standard flame or a standard fixed laser 240, such as shown by way of illustration in FIG. 9. For example, the curing station 170 includes a standard ultra-violet lamp 180, such as shown by way of illustration in FIG. 10. For example, the coring station 170 includes standard resistive elements, for example, as found in a standard oven 190, such as shown by way of illustration in FIG. 11A. Alternatively, the curing station 170 includes a standard tube furnace 200, such as shown by way of illustration in FIG. 11B. As another example, the curing station 170 includes a standard hot plate 210, such as shown by way of illustration in FIG. 12. As yet another example, the curing station 170 includes a standard heat gun 220, such as shown by way of illustration in FIG. 13. As yet another example, the coring station 170 includes a standard sintering laser 230, such as shown by way of illustration in FIG. 14.

Another embodiment includes a method of manufacturing a multi-fiber bundle 10. The multi-fiber bundle includes a multi-fiber bundle neutral axis. The multi-fiber bundle includes at least three standard optical fibers. The at least three optical fibers includes respective optical fiber neutral axes. The at least three optical fibers includes seams. The seams include tangential locations of the at least three optical fibers. The at least three optical fibers are registered such that at least a portion of the multi-fiber bundle neutral axis remains at a constant distance from at least a portion of the respective optical fiber neutral axes. The seams of the at least three optical fibers are fused.

Optionally, the at least three optical fibers include of a standard single mode optical fiber, a standard multi-mode optical fiber, a standard, gradient index optical fiber, a standard microstructered optical fiber, and/or a standard photonic crystal optical fiber. The at least three optical fibers include respective, standard in-fiber gratings. The respective, in-fiber gratings include a standard fiber Bragg grating, a standard long period grating, a standard super-structure grating, sad/or a standard tilted grating.

Optionally, registering the at least three optical fibers 30, 32, 34 comprises cold-drawing the at least three optical fibers through a standard aligning die, such as discussed above. Alternatively, registering the at least three optical fibers 30, 32, 34 includes mounting the at least three optical fibers on a standard fiber mount, such as discussed above.

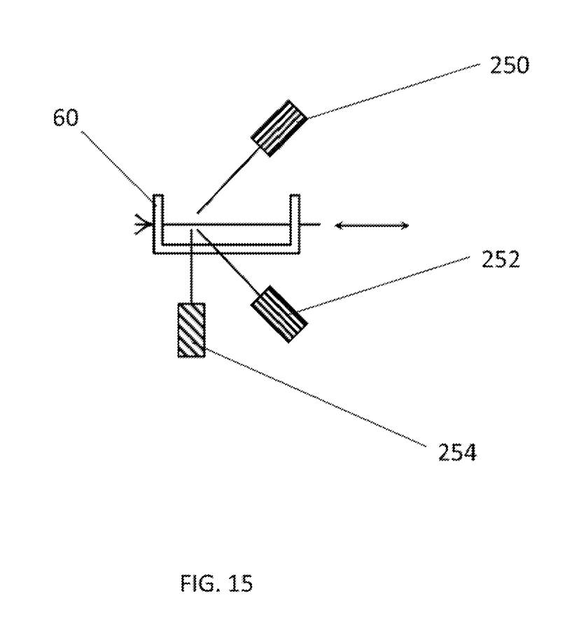

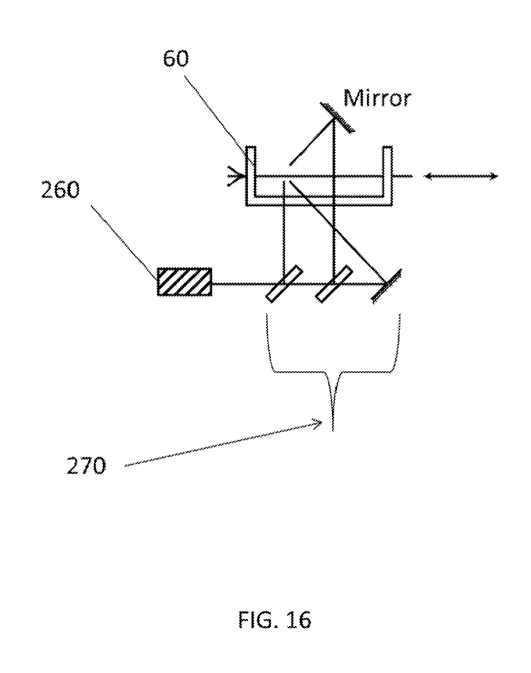

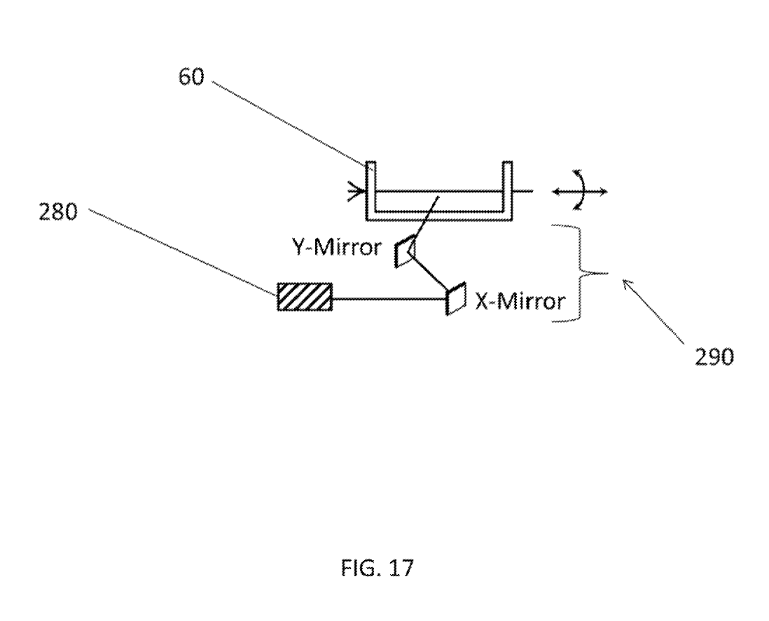

Optionally, fusing the seams of the at least three optical fibers comprises laser welding the seams using at least one standard CO₂ laser and/or a standard ultrafast laser. Optionally, fusing the seams of the at least three optical fibers comprises laser welding tire seams using a standard fixed laser, a standard scanning or rastering laser. One of ordinary skill in the art will readily appreciate that either the laser(s) must move, or the optical fibers must move, depending on the application. For example, one of ordinary skill in the art will recognize that multiple, fixed, standard lasers 250, 252, 254 can be used to fuse directly multiple scams of optical fibers moving past the lasers, such as shown by way of illustration in FIG. 15. One of ordinary skill in the art will appreciate that the number of lasers may depend on the number of optical fibers to be fused and whether standard beam delivery optics are operably employed between the lasers and the optical fibers. For example, if the intended multi-fiber bundle were to have four optical fibers to be directly feed by lasers, it may be advantageous to employ four disparately positioned standard lasers. Alternatively, for example, one of ordinary skill in the art will readily appreciate that a fixed standard laser 260 could be used in a configuration employing moving standard beam delivery optics 270 (e.g., standard beam splitters and/or standard mirrors to form a beam for each required seam) are used to directly fuse stationary optical fibers, such as shown by way of illustration in FIG. 16. Alternatively, for example, one of ordinary skill in the art will also readily appreciate that a standard scanning or rastering laser 280 and/or standard beam delivery optics would be used in a configuration wherein the laser or the laser's beam moves relative to the stationary optical fibers to fuse the optical fibers. Alternatively, for example, one ordinary skill to the art would also readily appreciate that a similar configuration entails the stationary scanning or rastering laser 280 cooperating with stationary standard beam delivery optics 290 and a standard fiber mount movable longitudinally and/or rotationally, such as shown by way of illustration in FIG. 17.

Optionally, the at least three optical fibers include at least three metalized optical fibers. Optionally, the at least three moralized optical fibers are metalized with titanium and gold. For example, titanium is advantageously used as an adhesion layer for gold.

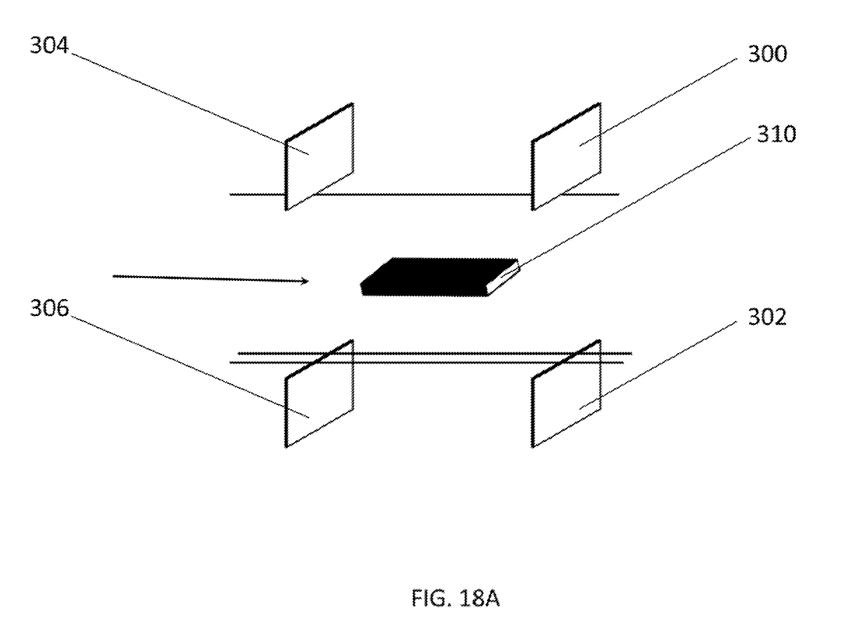

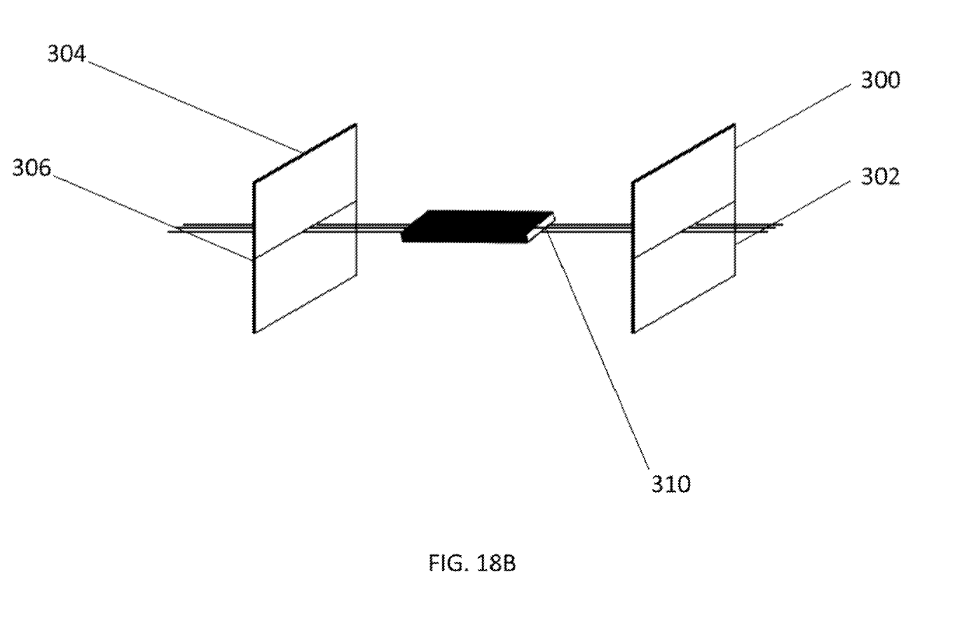

Optionally, the optical, fibers arc attached to, or held by, separated fiber mount wail blocks 300,302, 304,306. For example, standard solder 310 is positioned between the separated, fiber mount wall blocks 300, 302, 304, 306, as shown by way of illustration in FIG. 18A, and then the fiber mount wall blocks are brought together such that the optical fibers come in contact with the solder, as shown by way of illustration in FIG. 18B.

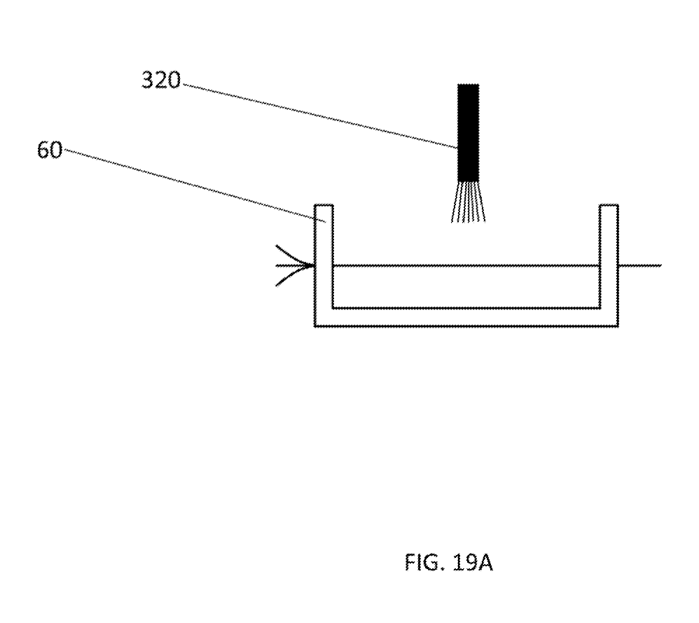

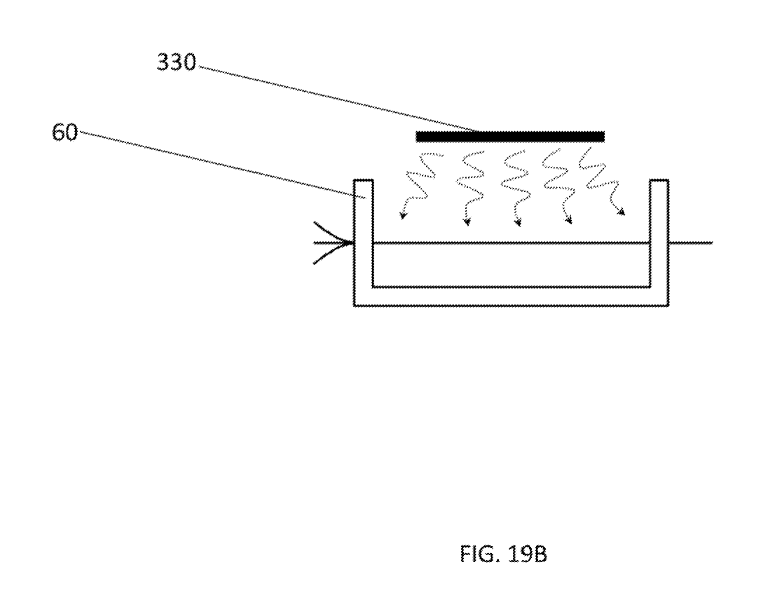

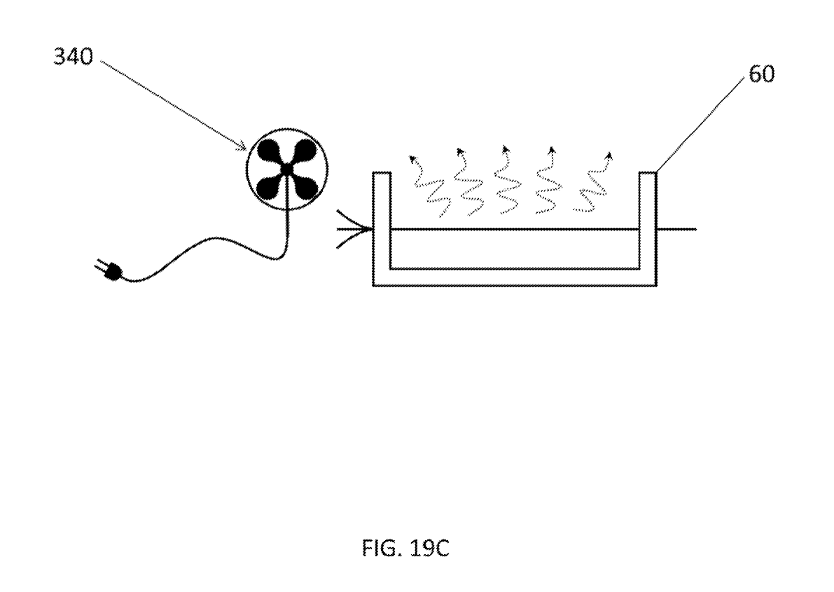

Optionally, the optical fibers are prepped for soldering by a standard brash 320 applying standard flux onto the optical fibers held, for example, by the fiber mount 60, such as shown by way of illustration in FIG. 19A. For example, the flux is an organic or inorganic material that comes in liquid or paste forms. For example, the flux-applying brush 320 is stationary, and the fiber mount is movable. Alternatively, the flux-applying brush 320 is movable longitudinally and/or rotationally, and the fiber mount is stationary. After the flux is brushed onto the optical fibers, the solder is heated by a standard heat source 330 (e.g., a standard hot plate), such as shown by way of illustration in FIG. 19B. After the solder is melted, a standard cooling source 340 (e.g., a standard fan) is used to cool the solder on the optical fibers, such as shown by way of illustration in FIG. 19C.

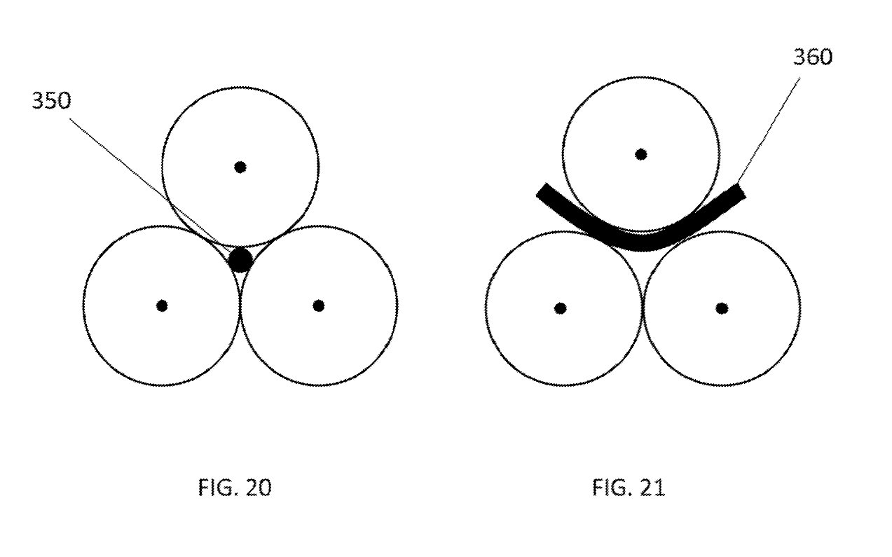

Optionally, fusing the seams of the at least three optical fibers includes using a standard solder, such as shown by way of illustration in FIGS. 20 and 21. Optionally, the solder includes a wire solder 350, such as shown by way of illustration in FIG. 20, or a ribbon solder 360, such as shown by way of illustration in FIG. 21. Optionally, the solder is a metal alloy, such as indium alloy or bismuth alloy.

It should be appreciated that various embodiments of the present invention may

be implemented as a sequence of computer-implemented acts or program modules running on a computing system and/or as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized, by one skilled in the art that these operations, structural devices, acts and modules may be implemented in software, firmware, special purpose digital logic, and any combination thereof without deviating from the spirit and scope of the present invention as described herein.

Although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

This written description sets forth the best mode of the invention and provides

examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed as new and desired to be protected by Letters Patent of the United States is:

1. A method of manufacturing a multi-fiber bundle, the multi-fiber bundle comprising a multi-fiber bundle neutral axis, the multi-fiber bundle comprising at least three optical fibers, the at least three optical fibers comprising respective optical fiber neutral axes, the method comprising:
registering the at least three optical fibers such that at least a portion of the multi-fiber bundle neutral axis remains at a constant distance from at least a portion of the respective optical fiber neutral axes;
coating the at least three optical fibers with an optical fiber coating material;
curing the at least three coated optical fibers.

2. The method according to claim 1, wherein the at least three optical fibers comprise at least one of a single mode optical fiber, a multi-mode optical fiber, a gradient index optical fiber, a microstructured optical fiber, and a photonic crystal optical fiber,
wherein the at least three optical fibers comprise respective in-fiber refractive index structures, the respective in-fiber refractive index structures comprising at least one of a fiber Bragg grating, a long period grating, a super-structure grating, a tilted grating, and a constant index change region.

3. The method according to claim 1, wherein said registering the at least three optical fibers comprises one of:
cold-drawing the at least three optical fibers through an aligning die; and
mounting the at least three optical fibers on a fiber mount.

4. The method according to claim 3, further comprising:
providing a coating cup, the coating cup comprising the aligning die, the coating cup containing the optical fiber coating material.

5. The method according to claim 3, wherein said coating the at least three optical fibers with an optical fiber coating material comprises at least one of:
passing the at least three cold-drawn optical fibers through a coating cup;
dip-coating the at least three mounted optical fibers with the optical fiber coating material;
brushing the optical fiber coating material on the at least three mounted optical fibers; and
spraying the optical fiber coating material on the at least three mounted optical fibers.

6. The method according to claim 1, wherein the optical fiber coating material comprises one of ultra-violet-curable epoxy, acrylate, and sol-gel, wherein the sol-gel comprises one of an aerogel, a xerogel, and a freeze-dried sol-gel.

7. The method according to claim 1, wherein said curing the at least three coated optical fibers comprises at least one of employing an ultra-violet lamp, employing a hot plate, employing an oven, employing a flame, employing a heat gun, and laser sintering.

8. A method of manufacturing a multi-fiber bundle, the multi-fiber bundle comprising a multi-fiber bundle neutral axis, the multi-fiber bundle comprising at least three optical fibers, the at least three optical fibers comprising respective optical fiber neutral axes, the at least three optical fibers comprising seams, the seams comprising tangential locations of the at least three optical fibers, the method comprising:
registering the at least three optical fibers such that at least a portion of the multi-fiber bundle neutral axis remains at a constant distance from at least a portion of the respective optical fiber neutral axes;
fusing the seams of the at least three optical fibers.

9. The method according to claim 8, wherein the at least three optical fibers comprise at least one of a single mode optical fiber, a multi-mode optical fiber, a gradient index optical fiber, a microstructured optical fiber, and a photonic crystal optical fiber, and
wherein the at least three optical fibers comprise respective in-fiber gratings, the respective in-fiber gratings comprising at least one of a fiber Bragg grating, a long period grating, a super-structure grating, and a tilted grating.

10. The method according to claim 8, wherein said registering the at least three optical fibers comprises cold-drawing the at least three optical fibers through an aligning die.

11. The method according to claim 8, wherein said fusing the seams of the at least three optical fibers comprises laser welding the seams using at least one of at least one CO2 laser and an ultrafast laser.

12. The method according to claim 8, wherein said fusing the seams of the at least three optical fibers comprises laser welding the seams using one of a fixed laser, a scanning laser, and a rastering laser.

13. The method according to claim 8, wherein the at least three optical fibers comprise at least three metalized optical fibers.

14. The method according to claim 13, wherein the at least three metalized optical fibers are metalized with titanium and gold.

15. The method according to claim 8, wherein said fusing the seams of the at least three optical fibers comprises using a solder.

16. The method according to claim 15, wherein said using a solder comprises using one of an indium alloy solder and a bismuth alloy solder.
